(19) United States
(12) Patent Application Publication
(10) Pub. No.: US 2008/0109300 A1
(43) Pub. Date: May 8, 2008

(54) System and Method for Managing the Distribution of Advertisements for Video Content

(76) Inventor: Brian J. Bason, South Orange, NJ (US)

Correspondence Address: CAPITAL LEGAL GROUP, LLC, 1100 River Bay Road, Annapolis, MD, 21409, US

(21) Appl. No.: 11/556,759

(22) Filed: Nov. 6, 2006

(51) Int. Cl. G06Q 30/00

(52) U.S. Cl. 705/14

(57) ABSTRACT

A method of distributing ad units for presentation with video content in a packet based communication system is provided. In one embodiment, the method includes storing campaign criteria for each of a plurality of ad units in a memory wherein the campaign criteria includes ad unit type information, network identifying information, temporal information, and constraint data. At least some of the ad units may comprise video data. The method may further include selecting an ad unit for delivery based on the campaign criteria and generating information identifying the selected advertisement. In addition, the method may further comprise determining that the anticipated impressions for an interval exceed the number of ad units to deliver during the interval, receiving a second request for an ad unit of a particular ad unit type, selecting one of a plurality of default ad units of the particular ad unit type; and transmitting information identifying the selected default ad unit.

### FIELD OF THE INVENTION

The present invention generally relates to a system and method for distributing advertisements and more particularly, to a system and method for managing the distribution of advertisements for presentation with video content over a packet based communication system such as the Internet.

### BACKGROUND OF THE INVENTION

In broadcast networks, such as broadcast television and radio, the same advertisement is typically inserted into the media stream for presentation to all the end users. In such networks, there typically is no means for determining with precision how many end users experienced an advertisement, which end users experienced the advertisement, or which end users responded to the advertisement.

In contrast, interactive networks such as the internet are more amenable to the selective and precise distribution of advertising. Internet advertising in which advertisements are sold based on the number of impressions or the number of click-throughs is well known. Typically, such internet advertisements comprise a still image (e.g., a banner ad) or a hyperlink that is presented as part of a static web page.

While the Internet has become a widespread means of communicating data, it is on the verge of becoming a primary means of communicating video data around the world. Most web pages include text, graphics, and other non-video data. However, as broadband becomes ubiquitous, more and more end users are receiving and transmitting video over the Internet. Video files and some audio files tend to be larger than other types of files. The availability of broadband allows users to transmit and receive larger files in acceptable time frames. This fact, at least in part, has led to the increase in the amount of video and audio data communicated over the Internet. As the communication of video and audio over the Internet increases, there is a need for a method and system for managing the distribution of advertisements associated with video and/or audio content.

There are a number of challenges to distributing advertisements associated with video content. First, in contrast to text or graphics content that form part of a static web page (e.g., photos, illustrations, tables, charts), video (and audio) content has a beginning, an ending, and may have one or more intermissions. Thus, considerations for advertisements for a static web page typically include where on the web page the advertisement will be placed. Advertisements associated with video content, however, may require determining both where and when (relative to the video) the advertisement will be presented. Consequently, a distribution system for use with video and/or audio content may need to consider temporal (when) the advertisement is presented in addition to where, relative to the content, the advertisement is presented. Second, it is desirable to distribute the advertisements substantially evenly across the advertising campaign period, which can be difficult due to the unpredictable nature of the internet.

These and other advantages are provided by various embodiments of the present invention.

### SUMMARY OF THE INVENTION

The present invention provides a method of distributing ad units for presentation with video content in a packet based communication system. In one embodiment, the method includes storing campaign criteria for each of a plurality of ad units in a memory wherein the campaign criteria includes ad unit type information, network identifying information, temporal information, and constraint data. At least some of the ad units may comprise video data. The method may further include selecting an ad unit for delivery based on the campaign criteria and generating information identifying the selected advertisement. In addition, the method may further comprise determining that the anticipated impressions for an interval exceed the number of ad units to deliver during the interval, receiving a second request for an ad unit of a particular ad unit type, selecting one of a plurality of default ad units of the particular ad unit type; and transmitting information identifying the selected default ad unit.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a functional block diagram of one example architecture that may be used to distribute advertising according to one example embodiment of the present invention.

FIG. 2 is an illustration of an example interface for providing information to add a new campaign in accordance with an example embodiment of the present invention.

FIG. 3 is an illustration of an example interface for providing information to select an advertisement in accordance with an example embodiment of the present invention.

FIG. 4 is an illustration of an example interface for providing third party tracking information in accordance with an example embodiment of the present invention.

FIG. 5 is an illustration of an example interface for providing advertising constraint information in accordance with an example embodiment of the present invention.

FIG. 6 is an illustration of an example interface for providing information to select an advertisement in accordance with an example embodiment of the present invention.

FIG. 7 is an illustration of an example interface for providing information to select an advertisement for editing in accordance with an example embodiment of the present invention.

FIG. 8 is an illustration of an example interface for providing information to edit a campaign in accordance with an example embodiment of the present invention.

FIG. 9 is an illustration of an example interface for providing information for the system settings in accordance with an example embodiment of the present invention.

FIG. 10 is an illustration of an example interface for providing and receiving information associated with reports for a campaign in accordance with an example embodiment of the present invention.

FIG. 11 is an illustration of an example interface for providing information to publish a new campaign in accordance with an example embodiment of the present invention.

FIG. 12 is an illustration of an example method for distributing advertisements in accordance with an example embodiment of the present invention.

FIG. 13 is an illustration of an example interstitial ad unit distributed in accordance with an example embodiment of the present invention.

FIG. 14 is an illustration of an example video skin ad unit and video player in accordance with an example embodiment of the present invention.

FIG. 15 is an illustration of an example video player in accordance with an example embodiment of the present invention.

### DETAILED DESCRIPTION OF ILLUSTRATIVE EMBODIMENTS

In the following description, for purposes of explanation and not limitation, specific details are set forth, such as particular networks, communication systems, computers, terminals, devices, components, techniques, advertisements, ad units, ad unit types, servers, communication paths, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, advertisements, ad units, ad unit types, servers, communication paths, data and network protocols, software products and systems, operating systems, development interfaces, and hardware are omitted so as not to obscure the description.

System Architecture and General Design Concepts

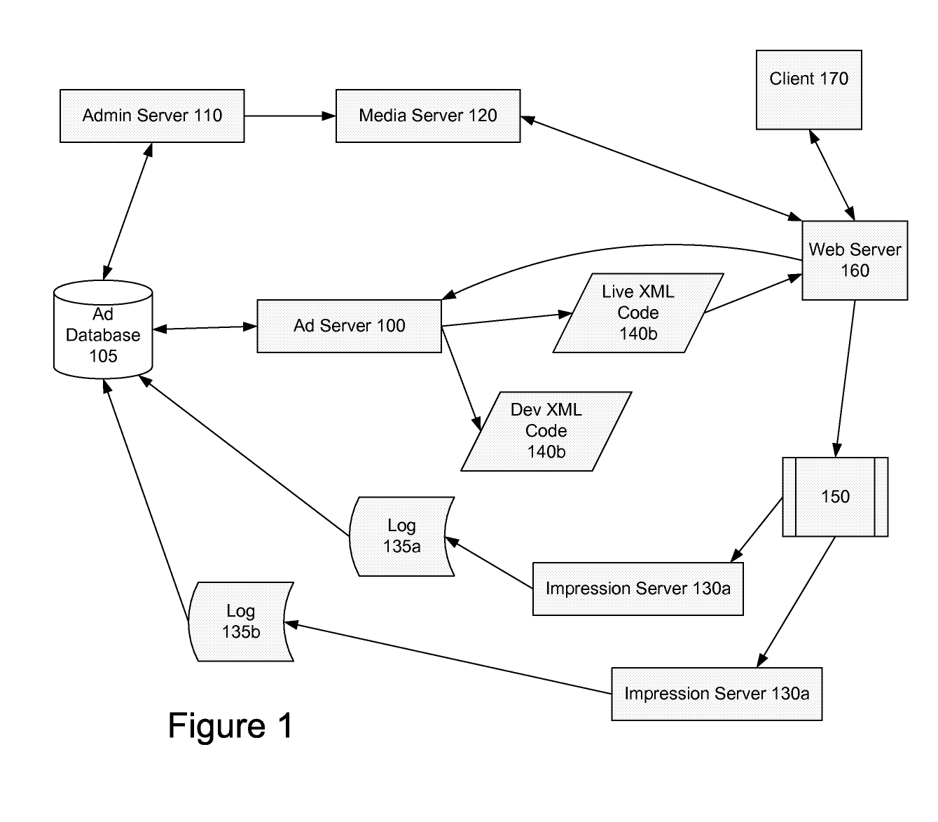

FIG. 1 illustrates the functional components of one example architecture that may be used to distribute advertising associated with video content (or audio content) according to one example embodiment of the present invention. This example embodiment includes an Ad Server 100, an Ad Database 105, an Admin Server 110, a Media Server 120, and an Impression Server 130. The servers described herein may include one or more computer systems that each include a processor, memory, user input and user output mechanisms, a network interface, and executable program code (software) stored in memory that executes to control the operation of the server. Various commercially available computer systems and operating systems software may be used to implement the hardware and the convention software. The components of each server may be co-located or distributed. In addition, all or portions of the same software and/or hardware may be used to implement two or more of the functional servers shown. Thus, in some embodiments the components of FIG. 1 may be considered functional components that employ the same hardware and some of the same program code. Other embodiments may include different functional components. In some alternate embodiments, all of the functional components of FIG. 1 may be performed by the web server that serves the client the web page.

The Ad Server 100 includes executable program code that includes one or more algorithms to select advertisements (also referred to herein as ad units) for distribution. Specifically, the Ad Server 100 may request and receive information from the Ad Database 105 that may include impression data, configurations setting, campaign criteria data, and other data. The Ad Server 100 may also store data in the Ad Database 105. In addition, the Ad Server 100 also may receive information from the web server 160 that will serve the advertisement (ad unit). For example, the web server 160 may receive a request for a web page that includes video content (or a video player) from a client 170. In response, the web server 170 may transmit information to the Ad Server 100 that allows the Ad Server 100, in conjunction with information from the Ad Database 105, to select the advertisement(s). In this example, the Ad Server 100 receives the information from the web server 160 and selects the advertisement based on one or more of the configuration settings, campaign criteria data, the date and time, the video content to be served, the domain name of the web site (which may be categorized into a sub-network or group), and other factors. Upon selecting the advertisement, the Ad Server 100 generates XML (Extensible Markup Language) code 140a that identifies the selected advertisement(s) and transmits the code 140 to the web server 160, which may then transmit the XML code 140a (or a portion of it) as part of (e.g., embedded in) a web page (a HyperText Markup Language (HTML) or Extensible HTML (EHTML) file) to the client 170 (e.g., a web browser executing on the end user's computing device). Alternately, the XML code 140a may be transmitted to the client 170 (e.g., browser) directly from the Ad Server 100, which may then request the advertisement (and in some embodiments the video or audio content) from the Media Server 120. In still another embodiment, the web page being served to the client 170 from the web server 160 may cause the client 170 to transmit the necessary information to the Ad Server 100, which causes the Ad Server 100 to select and transmit the advertisement(s) to the client 170.

Media Server 120 stores the advertisements. The XML code 140 received by the client web browser 170 may cause a request for the selected advertisement(s) (identified in the XML code 140) to be transmitted to the Media Server 120. In response to the request, the Media Server 120 may transmit the requested advertisement(s) to the client 170. Alternately, the web server 160 may receive the XML code 140 from the Ad Server 100, transmit a request to the Media Server 120 for the selected advertisement(s), receive the advertisement(s) from the Media Server 120, and then transmit the received advertisement(s) as part of (e.g., embedded in) a web page requested by the client 170.

The Ad Server 100 also may generate Developer XML code 140b, which simply allows the advertiser (or agent) to test and review the advertisement(s) before going live with the advertising campaign.

In addition to identifying the advertisement(s) selected by the Ad Server 100, the XML code 140a (or other code) executing at the web server 160 (or at the client 170 if the XML code is executed in the client browser) also may generate and transmit impression data that includes information of the advertisement(s) that was served (if served by the web server 170) or displayed (e.g., if displayed by a client 160). In addition, other data transmitted may include the date, time, information identifying the webpage in which the video or audio is embedded, information of the domain (e.g., the web site), information of the IP address (of the user and/or of the web server), user information (e.g., the location, address, sex, age, interests, hobbies, web pages previously viewed, domains visited, etc.) and other information such as information sufficient to determine whether a link associated with the advertisement was clicked through. The impression data is received by the impression server 130, which processes and writes the impression data to a log file 135.

As shown in FIG. 1, multiple Impression Servers 130a,b as well as fault tolerance techniques 150 (e.g., redundancies) may be used to ensure that all impression data is tallied and little or no data is inadvertently discarded or lost.

The Log File 135 provides temporary storage of the impression data, which is then periodically transferred to the Ad Database 105 for storage. In this example, the impression data may be stored in the Ad Database 105 when such storage does not lock the Ad Database 105 and prevent access thereto by the Ad server 100.

The Admin Server 110 allows administration of the system such as by interfacing with users to add and edit advertising campaign data, client (advertiser) data, and other information as described below. This information includes various data and parameters that may be used by the Ad Server 100 to select advertisements for distribution.

### Example Embodiments

In one example embodiment, the Ad Server 100 includes program code that executes to cause the Ad Server 100 to deliver the necessary number of advertisements, deliver the advertisements within a specified time period, and deliver the advertisements substantially evenly from day to day, from hour to hour, and within each hour. In doing so, the Ad Server 100 selects the advertisements based on various information collected by the Admin Server 110. In this example embodiment, the advertisements are distributed for presentation in conjunction with (e.g., before, after, simultaneously, etc.) video (which may include an audio portion) or audio. Generally, delivery of an advertisement results in an impression of the advertisement, which comprises a presentation of the advertisement to an end user. While the example of the present invention described herein is for providing impressions of advertisements, other embodiments of the present invention may be used to distribute advertisements to provide click-throughs of the advertisements or a combination of impressions and click-throughs.

The Admin Server 110 facilitates administration of the system and allows the user to provide and modify information to be used by the Ad Server 100 to select ad units for distribution. At the highest level, the Admin Server 110 allows the user to add a new campaign, edit an existing campaign, publish a campaign, view reports, and change system settings. The Admin Server 110 includes a plurality of interfaces that request and receive data from the user. In one example embodiment, the Admin Server 110 may include a web server that transmits information to, and receives information from, the user's browser via web pages. Thus, in this example the interfaces comprise web pages (HTML files), while other embodiments may employ other types of interfaces. In addition, in this example embodiment the Admin Server 110 allows an operator (who acts as the user) to enter data for a plurality of advertisers (who are clients of the operator). In other embodiments, the Admin Server 110 may allow the advertisers to act as the user (except for making some system setting changes).

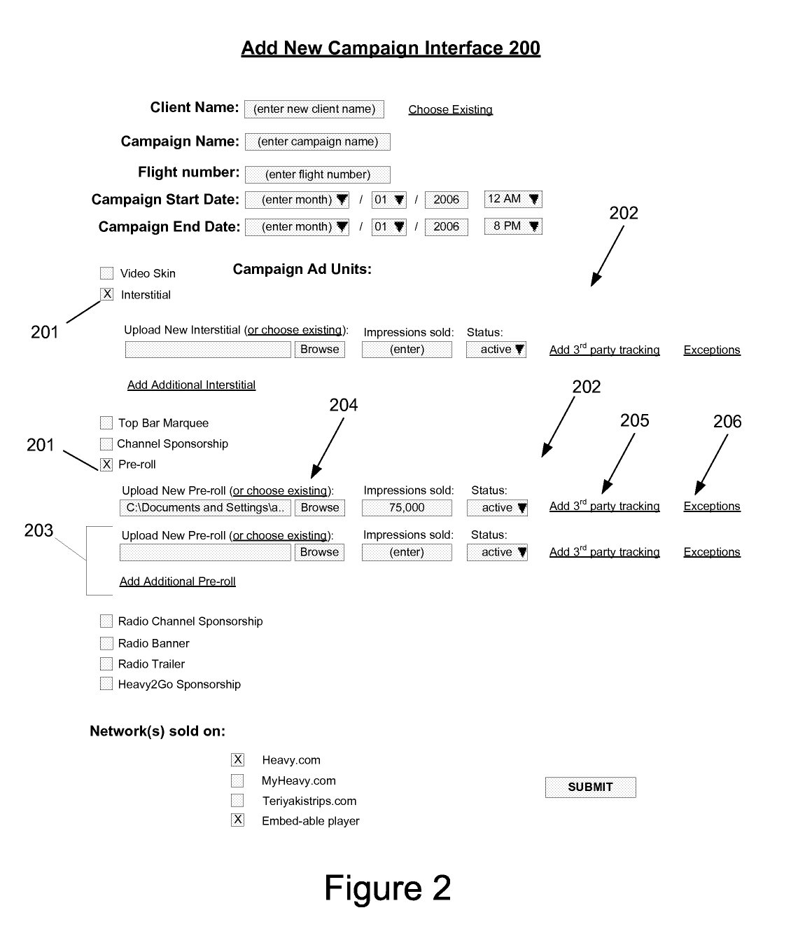

Referring to FIG. 2, the Add New Campaign 200 interface allows the user to enter information such as Client Name, Campaign Name, Flight, Campaign start date (which includes four (4) dropdown menus (one for month, day, year, and hour), Campaign end date (which includes four (4) dropdown menus (one for month, day, year, and hour). In addition, the user can select one or more check boxes to provide information of the Campaign Advertising Units. As shown in FIG. 1, the different types of advertising unit types include Video Skin, Interstitial, Top Bar Marquee, Channel Sponsorship, Pre-roll, Radio Channel Sponsorship, Radio Banner, Radio Trailer, and Heavy2GoSponsorship. Some or all these ad unit types may be transmitted to, and present to the user by, a video player. Others may be transmitted to, and present to the user, by a browser (e.g., a pop-up window) or an audio player.

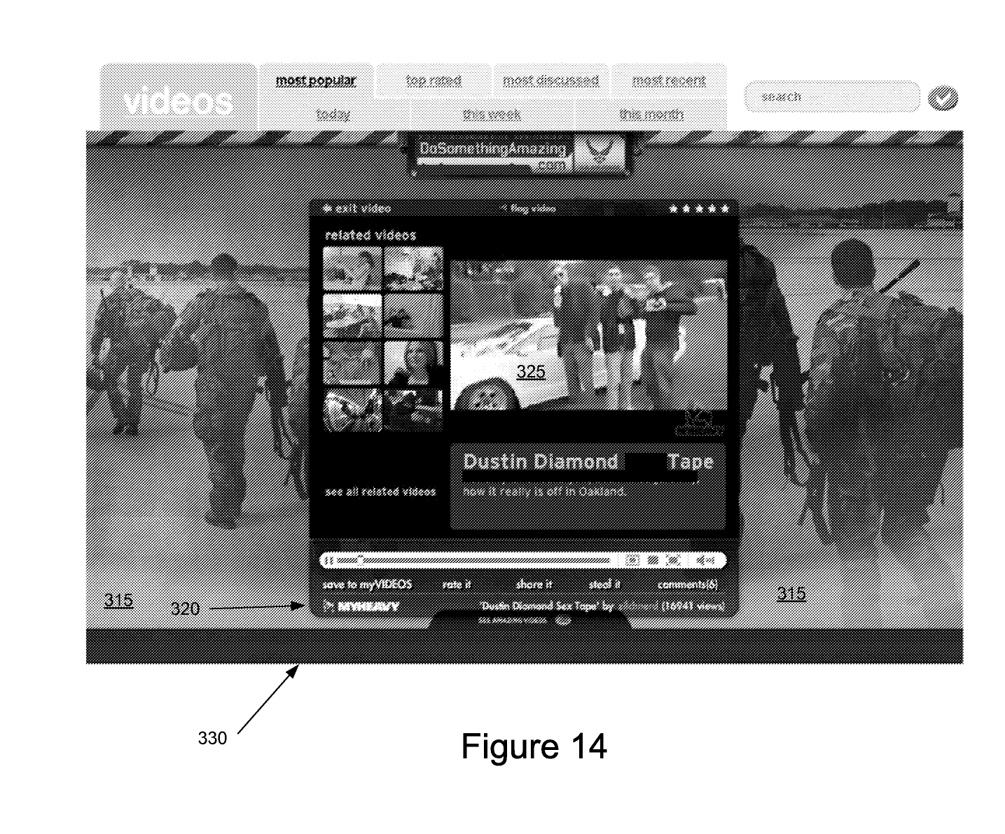

Each type of advertising unit is generally configured to display at a different time or location (relative to the video or audio content) from other advertising unit types. Thus, by categorizing the ad units into different ad unit types and selecting an ad unit of a particular type comprises selecting when the ad unit will be presented relative to the video or audio content. The various advertising unit types may be of the same or different file type (e.g., jpeg, swf, flv, mpg, etc.). In this embodiment, the Video Skin advertising unit type comprises a static graphic (e.g., a photograph) placed around the video content (and sometimes around the video player). FIG. 14 provides an example a Video Skin ad unit 315 that surrounds the video player 320 and content 325. The Video Skin type may be a gif, jpeg or other still image type, and may include an associated hyperlink (i.e., a click-through URL) to the advertiser.

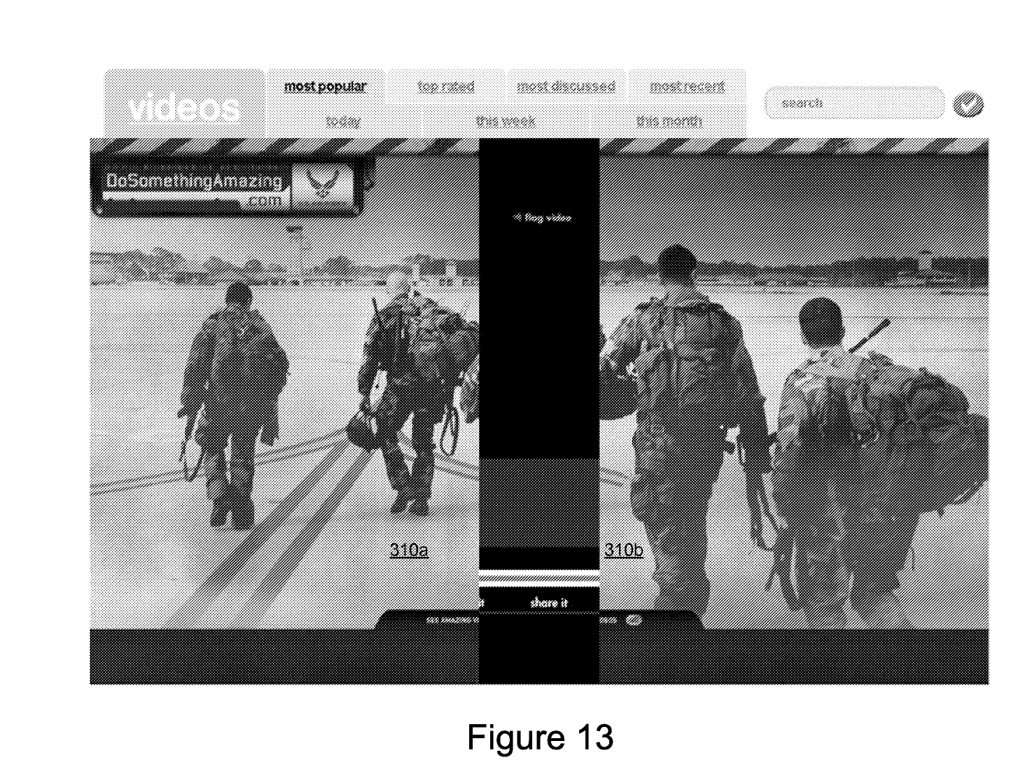

The Interstitial advertising unit type comprises one or more images (static or video) that are displayed prior to (or after) the video content and split apart into multiple portions just prior to the beginning of the video content (or come together just after the end of the video content), and may act as a pre-loader while the upcoming video is buffered or transmitted. In one example Interstitial, a jpeg image separates along a vertical line in a manner that is similar to two doors sliding apart to reveal the beginning of the video content. FIG. 13 provides an example of such an Interstitial ad unit 310 that has begun to separate into two portions 310a and 310b. The Interstitial advertising unit type may comprise one or more jpeg, gif, mpg or other files and may include an associated hyperlink (i.e., a click-through URL) to the advertiser.

The Top Bar Marquee advertising unit type may comprise a small rotating banner displayed adjacent the video content, and in this embodiment is displayed just above the content, but in other embodiments one or more Marquee advertising unit types could be located above, below and/or along side the video content. The Top Bar Marquee advertising unit type may comprises a swf (Shockwave® file) file or series of jpegs files (shown in sequence) and include an associated hyperlink to the advertiser.

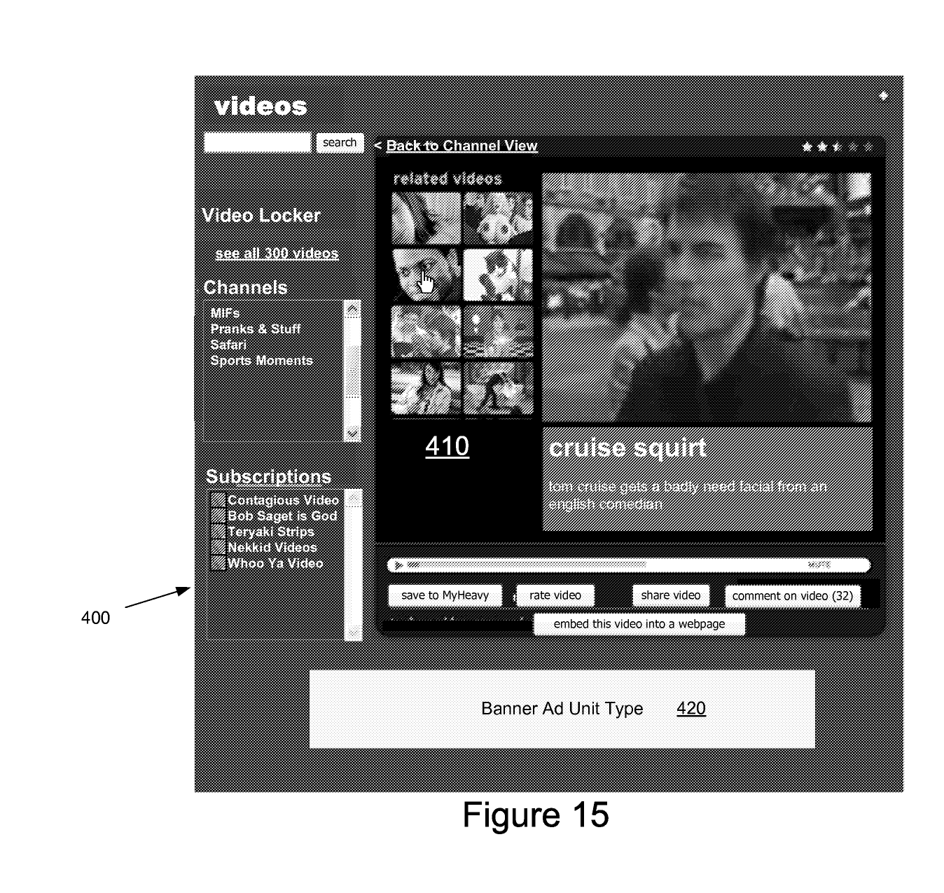

The Channel Sponsorship advertising unit type may comprise a still image (e.g., jpeg) that resides in the background of the channel selection area. For example, referring to FIG. 15 the Channel Sponsorship advertising unit 410 may be disposed in the “background” around and between the links associated with channels in the channel selection area. The Channel Sponsorship advertising unit type may include an associated hyperlink to the advertiser.

The Pre-roll advertising unit type comprises video that is presented to the viewer just prior to the beginning of the video content and may include an associated hyperlink to the advertiser. While not included in this example embodiment, other implementations may further include a Post-roll advertising unit type, which may comprise a video that is presented to the viewer at the end of the video content. In addition, other implementations may further include one or more Mid-roll advertising unit types that comprise a video that is presented to the viewer at one or more points (location and/or time) in the middle of the video content.

The Radio Channel Sponsorship advertising unit type may comprise a static banner placed at the top of a radio landing page (e.g., a web page in which a radio or audio player is embedded). The Radio Banner advertising unit type may comprise a rotating banner located at the top (or bottom) of an audio player (for audibly producing streaming audio data via the Internet) similar to the banner ad unit type 420 shown in FIG. 15. The Radio Banner advertising unit may comprise a still image (e.g., a jpeg image) served on a time basis (rotated with other ad units wherein each is displayed for a predetermined time period) rather than on click event. The Radio Trailer advertising unit type may comprise a rotating banner displayed within a radio player and may comprise a static or video image (e.g., jpeg image(s) or swf). The Heavy2Go Sponsorship advertising unit type may comprise a static graphic that frames heavy2go downloadable content.

A check box next to each advertising unit type allows the user to select one or more unit types to be included in the campaign. When a checkbox 201 is checked, an upload input form 202 becomes visible to identify and upload the ad unit file and to provide additional information. As shown for the Interstitial and Pre-roll ad unit types, (which have their checkboxes checked), the additional information may include the number of impressions to deliver and the status of the ad unit (enabled or disabled). In addition, when a checkbox is checked, an Add Additional <unit type> link appears, which when clicked causes an additional upload input form 203 to become visible to upload an additional unit of that unit type and supply the additional information. Additional Campaign Ad Unit types can be added in the System Settings section of the admin. All the information supplied may be stored in memory of the Admin Server 110, which may process the data and store some or all of the data in the AD Database 105.

To use the interface 200, the user checks a check box, clicks the Browse button, and selects a file (e.g., on the local computer) for uploading and inputs information of the number of impressions sold (i.e., purchased by the Client and to be delivered) for each ad unit (advertisement). In addition, the user can enter status information (e.g., Active or Disabled) for each Ad unit. Thus, the user can supply information of which ad unit type(s) will be used during a given campaign (e.g., Interstitial and Pre-roll), the number of advertisements for each selected ad unit type (one for Interstitial and two for pre-roll), and information of specific advertisement (e.g., the file names and impressions to deliver) for each advertisement to be used in the campaign.

Finally, the user can select on or more networks on which the ad units of the Campaign are to be delivered. In this example embodiment, the user can select Heavy.com, MyHeavy.com, and/or teriyakistrips.com, which comprise websites (i.e., domains). In addition, the user can select Embedded player, which comprises a video player than may be embedded in web pages and served by third party web servers. Each network may comprise a single domain and/or a group of domains. Some embodiments may include networks that comprise websites that are grouped based on the type of website (e.g., by parental rating, subject matter, or other criteria), category, demographical information, geographical information (e.g., where the business associated with the web site is located), and/or other grouping. In an alternate embodiment, the interface 200 may include an expandable menu detailing each ad unit within the campaign and may allow the user to override the campaign setting for a given ad unit.

When the user actuates (clicks) the Submit button, various fields may be checked to ensure the appropriate data is provided and, if so, the supplied data is transmitted to the Admin Server 110 for processing and storage.

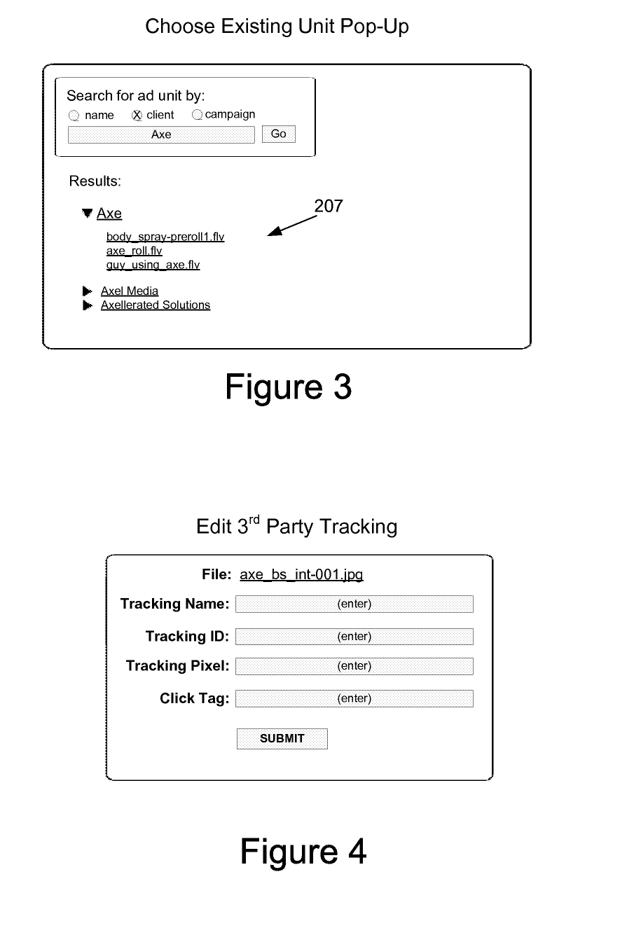

Referring to FIG. 2, for each ad unit to be uploaded the user may click on a Choose Existing hyperlink 204, Add 3^{rd} party tracking hyperlink 205, or an Exceptions hyperlink 206. If the user clicks on the Choose Existing link 204, a pop-up window is displayed as shown in FIG. 3. The new window allows the user to enter data to search for existing advertisements of that ad unit type based on name, the client, or the campaign. The user may enter data for a search and click Go. The search results are returned as links 207 and the user may select an advertisement by clicking on one of the displayed links 207, which will cause the filename of the selected ad unit to be populated into the upload file form text box of the Add Campaign interface of FIG. 2.

If the user clicks on the Add 3^{rd} party tracking hyperlink 205, a pop-up window as shown in FIG. 4. This interface allows the user to enter data for third party tracking of the ad unit such as a Tracking Name, Tracking ID, Tracking Pixel, and Click Tag. When the user clicks Submit button, the tracking data is saved and the window closed.

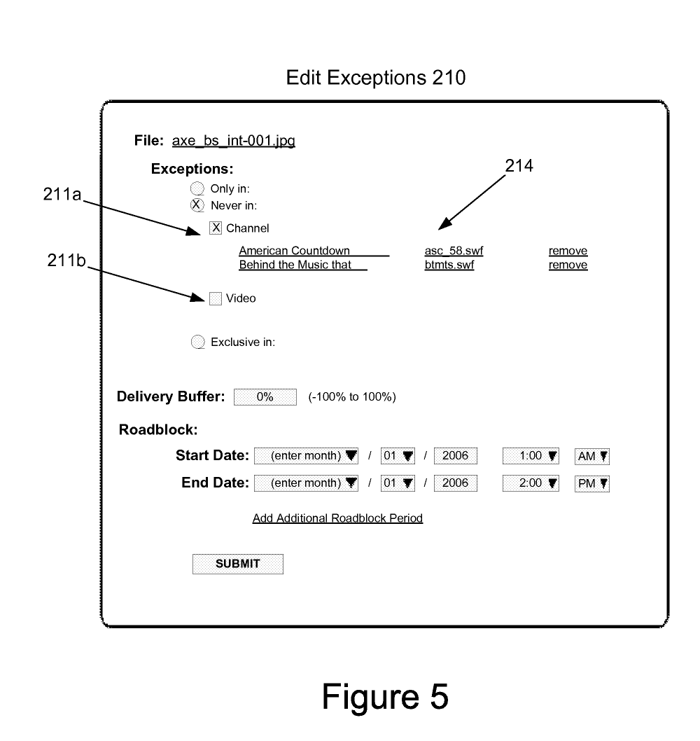

If the user clicks on the Exceptions link 206 (of Interface 200) for one of the units, the Edit Exceptions interface 210 of FIG. 5 is displayed. FIG. 5 is an illustration of an example interface for providing advertising constraint information for an ad unit in accordance with an example embodiment of the present invention. Other interfaces may be used to supply constraint data for a client, campaign, or ad unit type. In this example embodiment, the constraint data may include exception data and roadblock data. Specifically, the constraint data collected by the Edit Exceptions interface 210 allows the user to supply data used to control the videos, channels, and time frames that an ad unit will and/or will not be presented. Under the Exceptions heading, the user may select the “Only in”, “Never in”, or “Exclusive In” radio buttons to provide exception data. Selecting any of these radio buttons causes two addition checkboxes 211 to be displayed, namely a Channel checkbox 211a and a Video checkbox 211b.

As an example, by selecting the “Only in” radio button, the user may select one or more Channels and/or one or more Videos as the only Channel(s) and/or Video(s) with which the ad unit is presented. In addition, by selecting the “Never in” radio button, the user may select one or more Channels and/or one or more Videos with which the ad unit is never displayed. A Channel as used herein comprises a group of associated videos. For example, a particular Channel may include a group of videos that are selected by a particular person. Another channel may be a group of videos that contain similar subject matter (comedic video clips). Thus, the exception data allows a user (or advertiser) to indicate that the ad unit should only be (or should never be) presented along with content of particular Channel (which may include many videos) or video. By selecting the “Exclusive In” radio button, the user can indicate that the ad unit should be the only ad unit of that ad unit type presented along with the designated videos and/or channels (but does not preclude the ad unit from also being presented on other channels and with other videos). Different embodiments may request, receive, and use different constraint data. For example, other example embodiments may allow the user to which networks an ad unit should only be presented, never be presented, or network exclusive.

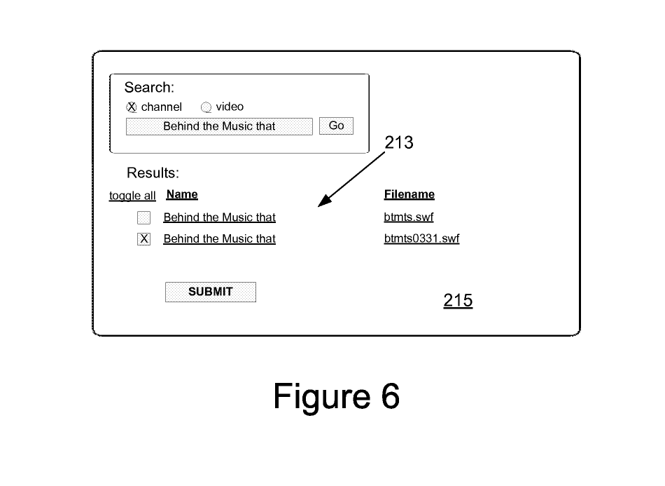

When a user checks the checkbox 211 associated with “Channel” or “Video”, the interface 215 of FIG. 6 is displayed, which allows the user to search for videos or channels. The user may enter data for a search and click Go. The search results 213 are returned as shown in FIG. 6 and the user may select one or more checkboxes associated with the displayed video(s) or channel(s). When the user clicks the Submit button of window 215, the name of the selected channels or videos and their filenames 214 are displayed in the Edit Exceptions interface 210 as shown in FIG. 5 and the window displaying interface 215 is closed.

Referring to FIG. 5, the user also may enter Delivery Buffer data, which allows the system to over deliver the advertisement. The Delivery Buffer allows the operator to compensate for overriding factors, such as compensating for third party tracking discrepancies. Finally, the user may enter Roadblock data which may comprises temporal and allows the user to enter data of a time period when the advertisement is the only ad unit of that ad unit type to be delivered. As shown multiple time periods (i.e., multiple roadblocks) may be entered by clicking on the Add Additional Roadblock Period. In this embodiment, a roadblock indicates that the ad unit is the only ad unit of that unit type to be delivered for all networks, all channels, and all videos. In other embodiments, a roadblock allows the user to indicate that the ad unit is the only ad unit of that unit type to be delivered for one or more networks, channels, and/or videos. Upon clicking the submit button, the data is stored in the memory of the local computer and transmitted along with other data from the Add New Campaign interface 200 to the Admin Server 110 for storage therein. In an alternate embodiment, the Delivery Buffer may be set for each campaign or for each ad unit.

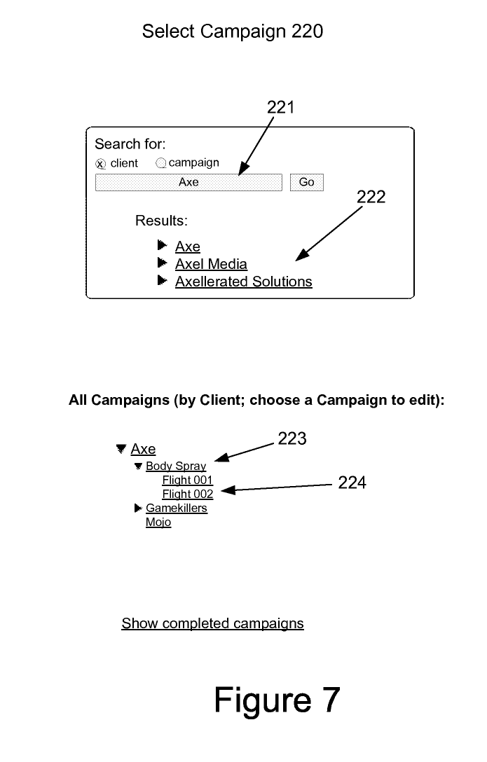

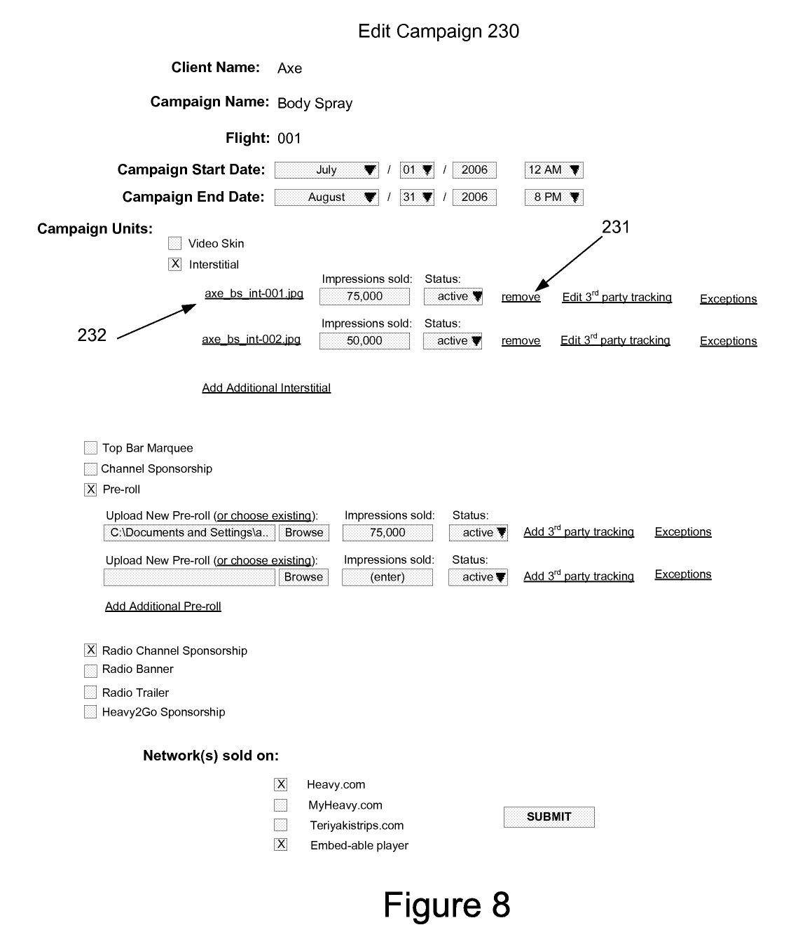

The user also may choose an existing campaign to edit, which may be accomplished, for example, via the Select Campaign interface 220 shown in FIG. 7. As shown, the user may input client information or campaign information to a search box 221 to perform a search that will return all the campaigns of a client (for a client search) or all campaigns meeting the search criteria (for a campaign search). Results of the search 222 may be shown under the search input text box 221. The user may select one of the search results 222 by clicking on the displayed link, which causes the associated campaigns to be displayed as shown towards the bottom of the figure. The user may click on the link of a campaign, which causes the campaign data to expand on the web page (as shown for top campaign “Axe”). The user may then select a Campaign 223 or Flight 224 to edit, which causes the interface 230 of FIG. 8 to be displayed. Additionally, the user may select the Show Completed Campaigns, which shows the completed campaigns and allows the user to select and view (but not edit) the campaign information of the completed campaigns.

FIG. 8 illustrates the Edit Campaign interface 230 wherein the user has selected the Axe client, Body Spray campaign, and Flight 001 for editing. To edit the campaign, the user may supply substantially the same information described above for adding a new campaign except that the user is not permitted to enter information for the Flight, Campaign Name, or Client Name. In addition, the user may select to remove an ad unit by clicking on the remove link 231 and may view an ad unit by clicking on the file name 232 of the ad unit. Data entered via the Edit Campaign interface 230 replaces the data previously stored in memory for use by the Admin Server 110.

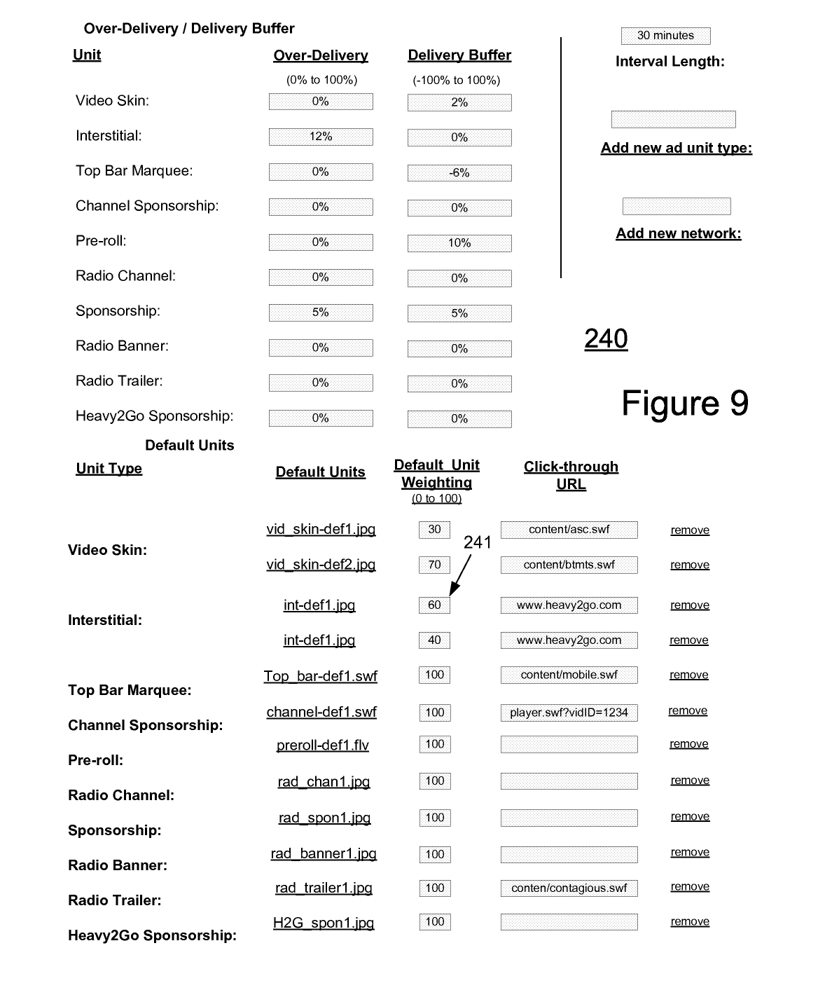

FIG. 9 illustrates an example interface 240 for allowing a system administrator to make changes to the system configuration. With minimal changes the previously described web page interfaces could be used by clients (i.e., advertisers), but the system changes accomplished via the System Settings interface 240 of FIG. 9 typically would be performed by the operator of the advertising distribution system.

Referring to FIG. 9, the user may modify the interval length to be fifteen minutes, thirty minutes, forty-five minutes, one hour, two hours, six hours, twelve hours, or twenty-four hours. For all values longer than one hour, a confirmation window will notify the user that the change may cause campaigns whose scheduled end is in the middle of the current interval to have a delayed ending. The user may also add additional ad unit types and networks. In addition, the user may change the Over-Delivery and Delivery Buffer percentages for each ad unit type (ranging from “−100” to “100”).

The bottom portion of the interface 240 allows the user to provide the Default Unit parameters. A default ad unit is an advertisement that may be delivered when the anticipated number of impressions for an interval exceed the number of ad units sold that are to be delivered during that interval. A list of the default ad units for each unit type is presented. Specifically, the list includes the file name for one or more advertisements that are the default ad units for that ad unit type. The first text field 241 associated with each ad unit type allows the user to enter integers between “0” and “100” to provide a Default Unit Weighting. The next text field allows the user to input or change the click-through URL associated with the default ad unit, which in this embodiment is a link to the advertiser's or product's web page. In addition, the user can click on the “remove” link to remove the default ad unit.

While not shown, the interface 240 may include an input (e.g., “Add New Default Unit for <unit type>” link) to allow the user to add a new default ad unit for any ad unit type. When clicked, an additional input field becomes visible to upload an additional default ad unit of that unit type. Additionally, the interface 240 may allow the user to supply information to enable or disable a default unit ad unit or ad unit type. Upon clicking a Submit button (not shown) all the data supplied to the interface 240 is transmitted to and stored on the Admin Server 110. In addition, an alert (e.g., pop-up) may be transmitted when certain non-standard configurations are present. For example, if the Delivery Buffer is set at “−100%”, weighting of all default units of a unit type may automatically be set to “0”.

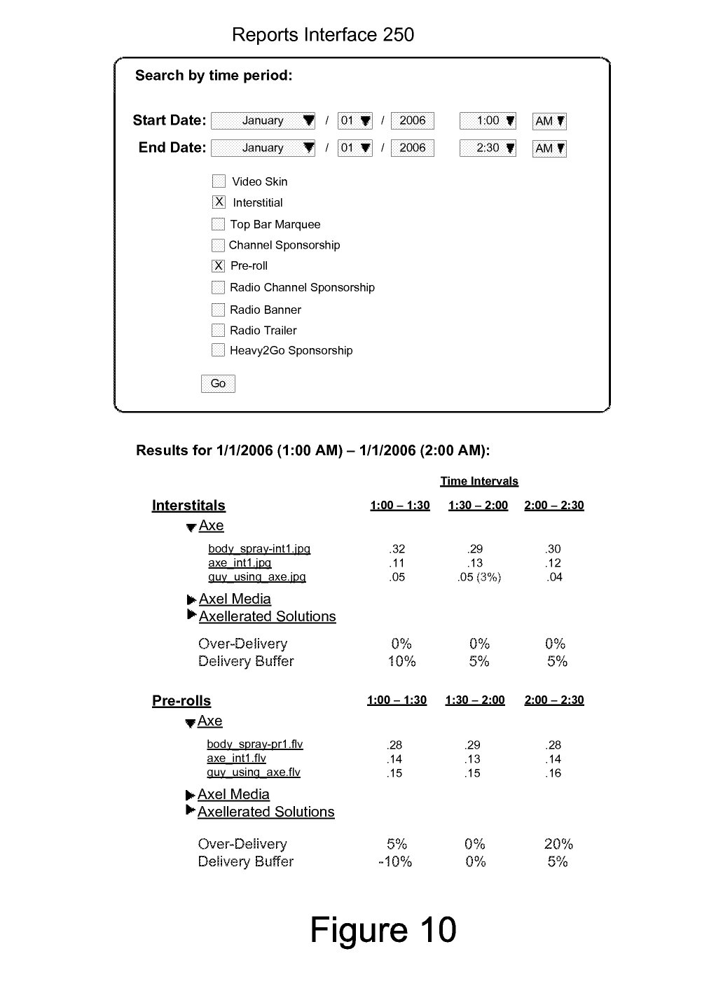

The system also includes an interface 250 that allows the user to customize and generate reports that include information of the delivery of advertisement. An example interface 250 for requesting such a report is shown in FIG. 10. As illustrated, the interface 250 allows the user to select a time period (start and stop dates) and one or more ad unit types. The results may include an archive of unit weighting, over-delivery, and delivery buffer data by Interval for each ad unit type and time period selected.

As shown in FIG. 10, the results may include a plurality of client names, which are expandable (by selection of the user) to provide the campaigns for the selected client. The percentages in the parenthesis indicate the ad unit's override delivery buffer value. The numbers represent the weights for that interval. Other reports may display the number of impressions, domains served the ad unit, networks served the ad unit, click-throughs, and other data.

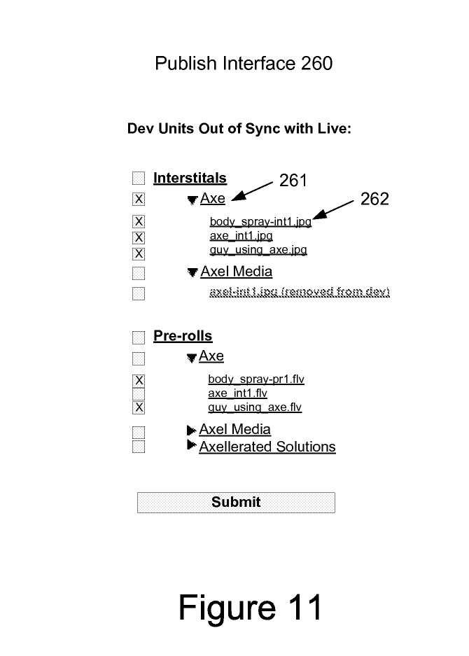

After data for one or more campaigns is entered into the system, the user can select which ad units to publish and whether the ad units are to be published live or as development units. A development unit is an ad unit presented for review by the advertiser or user prior to being published live. FIG. 11 provides an example publish interface 260 for providing such information for publishing the ad units “live” that displays multiple ad unit types and one or more clients and campaigns for each unit type. In this example embodiment, all ad unit types and clients that have campaigns that include a development ad unit that has not yet been published are displayed by default. The interface 260 may also include a search mechanism (such as described above) for searching for a client and/or campaign to publish. Upon selecting a check box associated with a client, the list expands to show the ad units for that unit type and client (as shown for Axe). Clicking on a file name 262 will cause the ad unit to be displayed in a separate window. The user may select one or more clients 261 or ad units 262 (and/or campaign) for publishing by checking the associated check box. When the submit button is clicked, the changes provided will be stored in memory and become active at the beginning of the following interval.

Other embodiments of the Admin Server 110 may include additional or fewer interfaces and all of some of such interfaces may be different than the interfaces described herein. In all of the interfaces, the new or different data received via any of the interfaces is stored in the memory and provided to the Ad Database 105 for use by the Ad Server 100. The files that constitute the ad units and default ad units may be transmitted to and stored in the Media Server 120. As will be evident to those skilled the art, the system may include a means of correlating the file name of the ad unit stored in the Ad Database 105 to the physical file stored on the Media Server to allow the Ad Server 100 to identify the ad unit in the XML code and any suitable means may be employed. Any information collected by the interfaces described herein, other information collected via other means (e.g., user surveys), or a combination thereof may be used to select ad units for delivery.

As discussed above, the Ad Server 100 includes executable program code that controls the distribution of the advertisements. The executable program code of the Ad Server 100 may be written in any suitable programming language and execute (run) on any suitable computer system. In one example embodiment, the Ad Server 100 is designed to deliver ad units substantially evenly across a plurality of days based on the currently available units and the associated campaign data. To do so, each day (or other time period) may be divided into a plurality of intervals. By default in this example embodiment, each day is divided into forty-eight half-hour intervals. In other words, the Interval Length is thirty minutes. As discussed above, the interval length is configurable via the Systems Settings interface.

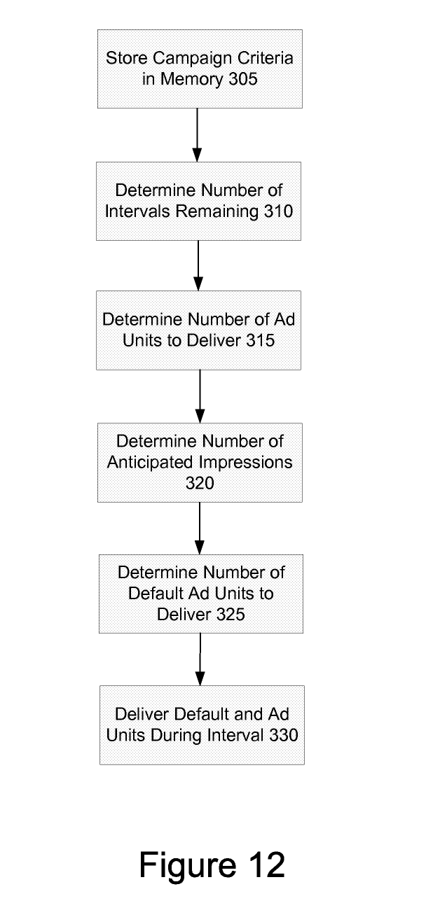

Referring to FIG. 12, one example embodiment for distributing advertisements for video content in a packet based network comprises storing campaign criteria in a memory for each of a plurality of campaigns 305, determining the number of intervals remaining for each campaign 310, determining the number of remaining ad units to deliver for each campaign 315, determining the number of anticipated impressions for an interval 320, determining a delivery number for each ad unit of each campaign for the interval (e.g., by dividing the number of remaining ad units to deliver for each campaign by the number of remaining intervals for that campaign), determining a delivery number of default ad units to deliver during the interval 325, and during the interval, delivering each ad unit of each campaign and the default ad units substantially according to the delivery number for the ad unit and default ad units 330, respectively. These steps may be performed for a plurality of ad unit types, such as, for example, for each of the ad unity types disclosed herein and/or others.

In some embodiments, it may be preferable to deliver the ad units and default ad units substantially even throughout the interval. Determining the number of default ad units may comprise subtracting the total number of ad units to deliver during interval from the number of anticipated impressions for the interval. Alternately, determining the number of default ad units may comprise determining the number of excess impressions. In addition, where more than one default ad unit is available for a given ad unit type, the method may include selecting a default ad unit for delivery based, at least in part, on weighting criteria, which may be provided, for example, via the system settings interface by an administrator.

At, or just prior to, the beginning of each interval, the number of ad units (impressions) to deliver for each ad unit type during the upcoming interval is determined at step 315. To do so, the program code of this example embodiment first determines the number of intervals remaining in the campaign at step 310, which may be accomplished in this example by the following calculation:

IntR=(TRC−TR)/Int
where:

IntR=the number of intervals remaining in the campaign;
TRC=the time remaining in the campaign;

TR=the time allocated for roadblocks during the campaign period; and

Int=interval length.

If any ad unit includes a roadblock (a time period when that ad unit is the only ad unit of that ad unit type that will be presented), the program code will exclude (e.g., subtract) the time allocated to roadblock intervals (TR) for all other active campaigns when determining the number of intervals remaining in their respective campaigns. If a roadblock starts or ends in the middle of an interval, the clipped intervals will stand on their own as intervals, such that no interval includes both roadblock and normal (non-roadblock) Flights. This process effectively overrides the Interval Length setting for the affected intervals.

After determining the number of intervals remaining in the campaign (IntR) at step 310, the number of ad units to deliver during the upcoming interval for each available ad unit for each unit type may be determined at step 315. In one example embodiment, this number of ad units to be delivered for an ad unit type of a campaign for an interval may be calculated as follows:

ID=(IDS−ITD)/IntR

where:

ID=the number of impressions to be delivered for an ad unit type for a campaign for the interval;

IDS=the number of impressions of the ad unit type sold for the campaign; and

ITD=the number of Impressions for the ad unit type delivered to date for the campaign.

Each ad unit type typically includes ad units and default units. As discussed, default units typically are delivered for impressions exceeding the sum of all ad units' interval impressions. In other words, if the number of total number of impressions of an interval exceeds (or is predicted to exceed) the total number of ad units to be delivered for all the campaigns (the sum of all IDs), the default ad units are delivered for the excess impressions. Rather than serving all ads units followed by all default units during an interval, it may be desirable to distribute the ad units and default units evenly throughout the interval(s).

In order to determine the number of impressions for default units of a particular unit type for an upcoming interval, it may be necessary to predict (e.g., estimate) the number of impressions for the upcoming interval. Assuming a sufficiently short interval length, averaging the percentage change in the number of impressions between the previous two intervals may provide a reasonable estimate of the percentage change between current interval and the next interval. In one example embodiment, this may be accomplished via the following computation:

Δ=[0.5*(Imp1Int/Imp2Int)]+[0.5*(Imp2Int/Imp3Int)]

where:

Δ=the anticipated percentage change in total impressions between current interval and the next interval;

Imp1Int=number of impressions during the most recent interval;

Imp2Int=number of impressions during the second most recent interval; and

Imp3Int=number of impressions during the third most recent interval.

In this embodiment, the anticipated percentage change in total impressions between current interval and the next interval is computed for each network. Other embodiments may determine the anticipated percentage change in total impressions between current interval and the next interval for groups of networks, domains, or for all networks. The total number of impressions anticipated for the upcoming interval may then be determined at step 320 as follows:

Intl=Imp1Int*(1+Δ)

In this embodiment the total number of impressions anticipated for the upcoming interval for all networks is determined via the above computation. In other embodiments, the computation may be performed or for groups of networks which may then be added together. In still another embodiment, the total number of impressions anticipated for the upcoming interval is determined for each network (and then may added together for ad units that are to be delivered across multiple networks). Other embodiments may employ other means of determining or estimating the number of impressions for the upcoming interval. The anticipated number of default units to deliver during the next interval may then be determined at step 325. In this example, the anticipated number of default units may be computed as follows:

TDU=Intl−Σ(Interval Impressions of all ad units)

where:

TDU=total number of default units to be delivered during the next interval.

As discussed above, default units are manually weighted against each other (Default Unit Weighting) in the System Settings section. If the anticipated total number of default units to be delivered (TDU) is positive, each default unit will have a non-zero number of impressions for the next interval, which in this example may determined by the following:

DefUI=TDU*DUW

where:

DefUI=number of impressions to allocated for a particular default unit;

TDU=total number of default units to be delivered during the next interval; and

DUW=the weighing for the particular default unit.

Finally, at step 330 the method includes delivering each ad unit of each campaign and default ad units substantially according to the delivery number for the ad unit and default ad units. In addition, these steps of FIG. 12 may be performed for a plurality of ad unit types, such as, for example, for each of the ad unity types disclosed herein and/or others. In one embodiment, the method steps additionally may be performed for each network that is available for delivery of ad units.

Peak traffic periods (intervals having the greatest number of impressions) can be utilized by some embodiments of the present invention to provide a controlled over-delivery of units to avoid overall or daily under-delivery of impressions. As discussed above, intentional over-delivery may be enabled or disabled in the System Settings. If over-delivery is enabled, each ad units' interval impressions will be delivered at greater than one hundred percent, as determined by the Over-Delivery Rate (a percentage between 0% and 100%, specified in the System Settings). The Over-Delivery Rate is used in conjunction with the Over-Delivery Inventory (the maximum number of units that can be used for over-delivery during an interval to determine the weighting of units in an over-delivery situation).

One method of controlling the over-delivery of ad units is to assign all units, both ad units and default units, a weighting on a normalized scale such as, for example, according to the following equation:

Unit Weighting=(ID)/[Σ(Interval Impressions of all available units)]

where:

Unit Weighting=weighting for the unit (default unit or ad unit);

ID=the number of impressions to be delivered for the interval for that ad unit type for that campaign; and

Σ(Interval Impressions of all available units) =total number of ad units of an ad unit type to be delivered for the upcoming interval.

If there is a roadblock for the ad unit during an interval, then that ad unit's weighting equals one and all other available units of that ad unit type are weighted at zero. Next over-delivery inventory may be determined according to the following:

ODInv=Intl−Σ(ID)

where:

ODInv=number of Over-Delivery Inventory impressions for an ad unity type;

Intl=anticipated number of impressions for the next interval for the ad unit type; and

Σ(ID)=sum total of all ad units of an ad unit type to be delivered for all campaigns.

The number over delivered units to be delivered may be computed according to the following equation:

ODUImp=UW*ODInv*ODR

where:

ODUImp=the Over-Delivered Unit Impressions to deliver;

UW=the Unit Weighting;

ODInv=the number for the Over-Delivery Inventory (which may be calculated above); and

ODR=the Over-Delivery Rate (as specified by the administrator)

By setting the Over-Delivery Rate to one hundred percent will result in no default ad units being delivered.

For each ad unit type, there is a Delivery Buffer option that is configurable in the Systems Settings. This value, which is a percentage between negative 100% and positive 100%, multiplies an ad unit's interval impressions by the specified percentage.

The number of impressions delivered may be less than anticipated due to imprecise estimations, addition of new roadblocks, or simply an unanticipated reduction in the number impressions. The program code may include code segments executable to reduce the likelihood that such an occurrence causes a campaign to end without delivering the desired click-throughs or impressions (e.g., the impressions sold). For example, if the length of time remaining in an ad unit's campaign is less than three days, the number of Interval Impressions to be delivered for the ad unit may be multiplied by 102%. This increase will cause the Interval Impressions from the first remaining interval of the 3^{rd}-to-last day to the final interval to decrease under normal circumstances (i.e., when using thirty minute intervals), thereby ensuring that unpredicted last-minute traffic dips or roadblock insertions do not cause a campaign to end without the desired impressions.

The above processes may be implemented for each ad unit type and for each campaign of each client at the beginning of each interval. The click-through URL (the link) associated with the advertisement, weighting, roadblock flag (true or false) and the network for each ad unit (both ad units and default units) may be used by the Ad Server 100 to select an advertisement and generate to an XML file at the beginning of each interval. In addition, in one example embodiment a different XML file may be created for each network (or alternately for each website) at the beginning of each interval. Web servers 160 (domains) that are a part of a particular network may be transmitted (from the Ad Server 100) the XML file for that network at the beginning of each interval in order to provide identification of the ad units to be served during the interval. In this embodiment the XML file may contain information identifying the ad units (for each ad unit type) available for the interval and ad unit selection data (e.g., weighting information and other information), which allows the web server 160 to select the ad unit to be delivered at each request (e.g., a client request for a web page). Thus, in this embodiment, a portion of the computations used to select the ad unit (e.g., via the equations provided herein) may be implemented in a distributed fashion such as implementing a portion on the Ad Server 100 and a portion on the web server 160.

Alternate embodiments of the present invention may also allow for some networks to be allocated a higher priority (e.g., a weighting) for the delivery of ad units. The priority allocation may be assigned by the system administrator, determined (e.g., via program code) based on campaign criteria and network parameters, assigned by the client, and/or via other means. In addition, other embodiments may further use historical data to deliver ad units more efficiently. For example, some or all networks may receive greater traffic during some time periods of the day and/or days of the week. By processing historical data, these trends can be identified which may be used to more accurately estimate the anticipated impressions for upcoming intervals. In another embodiment, the system may select and serve targeted ad units that are selected based on end user data. The user data may include, or be derived from, data stored in memory from end-user surveys, cookies, the fact that a user has seen or responded (clicked through) one or more previously seen ad units; and/or other data. In addition, some embodiments may additionally select advertisements based on the amount bid by the advertiser in comparison with the amounts bid by other advertisers.

Instead of performing the described method steps for each interval, an alternate embodiment may perform ongoing real-time process steps to perform the computations described herein, including weighting calculations. For example, rather than computing the data at the beginning of each interval, the computations may be calculated each time a request for an ad unit is received, which may be desirable in instances when the actual impressions does not match the anticipated impressions. Thus, the processes may be essentially real-time. Rather an even distribution of ad units, the system can be set up to ramp up (back load) or ramp down (front load) the delivery of ad units. For example, back loading, in one example, may include that the ad units delivered for each day (or other time period) is slightly greater than the number delivered the previous day until a peak day arrived (after which delivery of ad units would be constant each day or less each day until the end of the campaign).

Based on the above described methodology, where the upcoming interval experiences under-delivery, the amount that each ad unit is under-delivered is, in effect, distributed over the remaining intervals of the campaign. In an alternate embodiment, where the upcoming interval experiences under-delivery, the amount that each ad unit is under-delivered is added to the next interval's delivery requirement for that ad unit, which may allow for substantial under-deliveries to take advantage of peak traffic periods to thereby overcome the accumulated under-deliveries.

As discussed, some or all the ad units may be delivered to, and presented to the user by, a video player (or audio player), which comprises a software program that executes on the user's computer. One example of such a video player 400 is shown in FIG. 15. The video player of this example embodiment may allow the end user to hear audio content (e.g., Internet radio), hear and see video content, upload video content to the media server, select and create channels, search for videos and/or channels, subscribe to a channel, and take other actions. Channels may be considered a play list that is created by a first user. Other users may subscribe to or select the Channel in order to view the videos of the Channel. When the first user selects additional videos for the Channel, the other users who are subscribers to that channel will also get access to the additional videos. In one example embodiment, a pop-up window is initiated and the video player is disposed over the pop-up window with the ad unit, such as a video skin ad unit type, presented in the pop-up window. FIG. 14 shows an example of such an embodiment with the ad unit 315 presented in the pop-up window 330 and the video player 320 disposed on top of the ad unit 315. Thus, the video skin ad unit type surrounds substantially around the entire video player 320 and video content 325. In either instance, the video player 320/400 or the window 330 presenting the ad unit may transmit a request for an ad unit (in some embodiments), transmit notification of the impression, and/or transmit notification of a click-through of the ad unit.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

1-41. (canceled)

42. A method of distributing advertisements with video content via a packet based network, comprising:
storing a plurality of advertisements in a memory;
transmitting at least some of the plurality of advertisements to a plurality of clients for presentation of the advertisement concurrent with the video content and adjacent at least a first side and a second side of a video player presenting the video content;
wherein the video content is requested as a result of a user actuation of a hyperlink in a web page received by each of the plurality of clients;
wherein the web pages received by the plurality of clients form part of a plurality of different web sites; and
wherein different advertisements are transmitted to at least some of the plurality of clients.

43. The method according to claim 42, wherein the web pages received by the plurality of clients are transmitted to the clients from one or more web servers and the video content is received by the clients from one or more remote servers that are different from the one or more web servers.

44. The method according to claim 42, further comprising:
receiving a request for an advertisement from each of the plurality of clients; and
selecting an advertisement from the plurality of advertisements for each request.

45. The method according to claim 44, wherein said selecting comprises selecting an advertisement based on the video content presented.

46. The method according to claim 44, wherein said selecting comprises selecting an advertisement based a channel associated with the video content presented.

47. The method according to claim 42, further comprising:
receiving a data request as a result of a user actuation of a hyperlink associated with one of the plurality of advertisements at a first server; and
storing information of the user actuation in a memory.

48. The method according to claim 47, further comprising:
transmitting information of the data request from the first server;
receiving the information of the data request at a second server; and
transmitting content from the second server to a client initiating the data request.

49. The method according to claim 42, wherein the advertisement is formed, at least in part, by a Flash Video file type.

50. A method of presenting advertisements with video content via a packet based network, comprising:
at each of a plurality of clients:
receiving a web page that includes a hyperlink for requesting video content from a web server, the web page forming part of a web site;
receiving an actuation of the hyperlink;
in response to the actuation, transmitting a request for the video content;
receiving the video content;
presenting the video content in a video player on a display, the video player having a first side and a second side;
receiving an advertisement; and
concurrently with said presenting, presenting the advertisement adjacent at least the first side and the second side of the video player and wherein the advertisement includes an associated ad hyperlink.

51. The method according to claim 50, wherein the web pages received by the plurality of clients form part of a plurality of web sites and the advertisements received and presented are different for multiple clients of the plurality of clients.

52. The method according to claim 50, further comprising:
receiving a user actuation of the ad hyperlink; and
transmitting a request for data in response to the user actuation.

53. The method according to claim 52, further comprising:
receiving the request for data at a first server; and
storing information of the user actuation in a memory.

54. The method according to claim 53, further comprising:
transmitting information of the request from the first server;
receiving the information of the request at a second server; and
transmitting content from the second server for presentation by the client originating the request for data.

55. The method according to claim 50, further comprising transmitting an advertisement request in response to said receiving the actuation of the hyperlink.

56. The method according to claim 55, wherein the request for the video content and the advertisement request are transmitted to different destinations.

57. The method according to claim 55, further comprising at a second server:
storing a plurality of advertisements in a memory;
receiving the advertisement request;
selecting an advertisement from the plurality of advertisements; and
transmitting the selected advertisement for presentation on the display.

58. The method according to claim 57, wherein said selecting comprises selecting an advertisement based on the video content.

59. The method according to claim 57, wherein said selecting comprises selecting an advertisement based a channel associated the video content.

60. The method according to claim 50, wherein said presenting the advertisement comprises presenting the advertisement substantially around the entire video player.

61. The method according to claim 50, wherein the advertisement is formed, at least in part, by a Flash Video file type.

62. A method of presenting advertisements with video content via a packet based network wherein a plurality of web pages are stored on one or more web servers and wherein each web page forms part of a different web site and includes a hyperlink associated with video content and wherein a plurality of the hyperlinks are associated with different video content, the method comprising:
storing a plurality of advertisements in a memory of a first server;
wherein each of the plurality of advertisements is configured to be displayed adjacent a perimeter of a video player;
wherein the plurality of web pages are transmitted to a plurality of clients from the one or more web servers;
receiving at the first server, from each of the plurality of clients, a request for an advertisement initiated as a result of actuation of the hyperlink associated with video content; and
for each received request, transmitting from the first server one of the plurality of advertisements to the client originating the request for display adjacent the perimeter of the video player and concurrent with presentation of the video content by the video player.

63. The method according to claim 62, further comprising transmitting the video content associated with the hyperlink from a second server to each of the plurality of clients, and wherein the second server is different from the one or more web servers transmitting the plurality of web pages that include the hyperlink.

64. The method according to claim 62, further comprising:
receiving a data request from a client as a result of a user actuation of a hyperlink associated with the advertisement at a second server; and
storing information of the user actuation in a memory.

65. The method according to claim 64, further comprising:
transmitting information of the data request from the second server;
receiving the information of the data request at a third server; and
transmitting content from the third server to the client.

66. The method according to claim 62, wherein the video content is transmitted to each of the plurality of clients from a second server that is different from the first server.

67. The method according to claim 62, further comprising:
storing a plurality of first advertisements in a memory;
wherein each of the plurality of first advertisements includes a plurality of sections that are configured to separate prior to presentation of the video content to reveal the video player; and
for at least some of the received requests, transmitting one of the plurality of first advertisements to the client originating the request.

68. The method according to claim 62, wherein each of the plurality of advertisements is configured to be displayed adjacent a first side and adjacent a second side of the video player.

69. The method according to claim 62, further comprising selecting an advertisement based on the video content associated with the hyperlink.

70. The method according to claim 62, further comprising selecting an advertisement based a channel associated the video content associated with the hyperlink.

71. The method according to claim 62, wherein the plurality of advertisements are formed, at least in part, by a Flash Video file type.

72. A method of presenting advertisements with video content via a packet based network, comprising:
storing a plurality of advertisements in a memory of a first server;
wherein each of the plurality of advertisements is configured to be displayed over a video player and includes a plurality of sections that separate to reveal the video player;
receiving, from each of the plurality of clients, a request for an advertisement initiated as a result of actuation of a hyperlink associated with video content; and
for each received request, transmitting one of the plurality of advertisements to the client originating the request.

73. The method according to claim 72, wherein each hyperlink associated with video content forms part of a web page and the video content associated with the hyperlink is received from a second server by each of the plurality of clients, and wherein the second server is different from a web server from which the web page is received.

74. The method according to claim 72, further comprising:
receiving a data request file from a client as a result of a user actuation of a hyperlink associated with the advertisement at a second server; and
storing information of the user actuation in a memory.

75. The method according to claim 74, further comprising:
transmitting information of the data request from the second server; receiving the information of the data request at a third server; and
transmitting content from the third server to the client.

76. The method according to claim 72, further comprising transmitting the video content to each of the plurality of clients from a second server that is different from the first server.

77. The method according to claim 72, wherein each of the plurality of advertisements includes a first section and a second section that separate laterally to reveal the video player.

78. The method according to claim 72, wherein each of the plurality of advertisements includes a first section and a second section that separate vertically to reveal the video player.

79. The method according to claim 72, wherein at least some of the plurality of advertisements are configured to have multiple sections that come together to cover the video player subsequent to presentation of video content.

80. The method according to claim 72, further comprising selecting an advertisement based on the video content associated with the hyperlink.

81. The method according to claim 72, further comprising selecting an advertisement based a channel associated the video content associated with the hyperlink.

82. The method according to claim 72, wherein the plurality of advertisements are formed, at least in part, by a Flash Video file type.
